(19) United States
(12) Patent Application Publication
(10) Pub. No.: US 2024/0134588 A1
(43) Pub. Date: Apr. 25, 2024

(54) INFORMATION PROCESSING DEVICE AND PROGRAM

(71) Applicant: FUJIFILM CORPORATION, Minato-ku, Tokyo (JP)

(72) Inventor: Manami NITTA, Kanagawa (JP)

(21) Appl. No.: 18/546,598

(22) PCT Filed: Feb. 10, 2022
(86) PCT No.: PCT/JP2022/005438

§ 371 Date: Aug. 15, 2023

(30) Foreign Application Priority Data
Feb. 18, 2021 (JP) 2021-024679

(51) Int. Cl. G06F 3/14

(52) U.S. Cl. CPC G06F 3/14

(57) ABSTRACT

A processor of an information processing device according to the present invention acquires state information which indicates the state of the information processing device, displays the acquired state information in a notification area, which is a part of an operation screen for operating the information processing device, when the operation screen is displayed on an external terminal device via a network, and changes the order of priority of the state information to be displayed in the notification area in accordance with the display content of the operation screen which is being displayed on the terminal device, in a case in which there is plural pieces of the acquired state information.

### TECHNICAL FIELD

The present disclosure relates to an information processing device and a program.

### BACKGROUND ART

Japanese Patent Application Laid-Open (JP-A) No. 2006-107301 discloses an information processing device in which, in a system in which an image forming apparatus can be operated from a web application, in the case of an error in the image forming apparatus, an error screen is also displayed on a screen of the web application that is not directly related to the error, and thus, convenience in terms of operability of a user is improved while solving a problem that operability of the image forming apparatus is not considered.

### SUMMARY OF INVENTION

### Technical Problem

In recent years, some information processing devices such as image forming apparatuses have a function of displaying an operation screen on an external terminal device connected via a network interface. In an information processing device having such a function, in order to avoid setting failure due to an abnormal state of the own device, inappropriate operation affecting another user in use, and the like, a notification area for displaying state information indicating a state of the own device is provided on an operation screen to be displayed on an external terminal device.

For example, in a case where information that can be displayed in the notification area on the operation screen is limited, such as a case where a display area of the notification area is limited, there is a possibility that only some of the state information can be displayed in the notification area even in a case in which there is a plurality of pieces of state information to be displayed. As a result, there may occur a situation in which state information having little relationship with the operation content is displayed for the current user, and state information important for the current operation content is not displayed.

An object of the disclosure is to provide an information processing device and a program capable of preventing occurrence of a situation in which state information important for a current user is not displayed even in a case where displayable information is limited in a notification area for displaying state information indicating a state of the own device.

### Solution to Problem

According to a first aspect of the disclosure, there is provided an information processing device including: a processor, in which the processor configured to: acquire state information which indicates a state of the information processing device, cause display of the acquired state information in a notification area, which is a part of an operation screen for operating the information processing, when the operation screen is displayed on an external terminal device via a network, and change an order of priority of the state information to be displayed in the notification area according to display content of the operation screen displayed on the terminal device, in a case in which there are a plurality of pieces of the acquired state information.

According to a second aspect of the disclosure, in the information processing device according to the first aspect, the processor is configured to change the order of priority of the state information to be displayed in the notification area according to the display content of the operation screen displayed on the terminal device and authority of an operator operating the terminal device.

According to a third aspect of the disclosure, in the information processing device according to the second aspect, the processor is configured to change the order of priority of the state information to be displayed in the notification area using a priority preset according to a content of the state information for each combination of the display content of the operation screen displayed on the terminal device and an executable operation determined based on the authority of the operator operating the terminal device.

According to a fourth aspect of the disclosure, in the information processing device according to any one of the first to third aspects, the processor is configured to change the order of priority of the state information to be displayed in the notification area according to the display content of the operation screen displayed on the terminal device and a progress status of the processing performed by an operator via the terminal device.

According to a fifth aspect of the disclosure, in the information processing device according to the fourth aspect, the processor is configured to change the order of priority of the state information to be displayed in the notification area using a priority preset according to a content of the state information for each combination of the display content of the operation screen displayed on the terminal device and a current progress status of the processing performed by the operator via the terminal device.

According to a sixth aspect of the disclosure, in the information processing device according to any one of the first to fifth aspects, the processor is configured to switch a screen to be displayed among a plurality of operation screens and displays the screen on the terminal device, by an operation of an operator operating the terminal device.

According to a seventh aspect of the disclosure, there is provided a program executable by a computer to perform: a step of acquiring state information which indicates a state of an information processing device; a step of displaying the acquired state information in a notification area, which is a part of an operation screen for operating the information processing device, when the operation screen is displayed on an external terminal device via a network; and a step of switching an order of priority of the state information to be displayed in the notification area according to display content of the operation screen displayed on the terminal device, in a case in which there is a plurality of pieces of the acquired state information.

### Advantageous Effects of Invention

According to the information processing device of the first aspect of the disclosure, even in a case where displayable information is limited in the notification area for displaying the state information indicating the state of the own device, it is possible to prevent occurrence of a situation in which state information important for a current user is not displayed.

According to the information processing device of the second aspect of the disclosure, even in a case where displayable information is limited in the notification area for displaying the state information indicating the state of the own device, it is possible to prevent occurrence of a situation in which the state information important for the current user is not displayed corresponding to the operator.

According to the information processing device of the third aspect of the disclosure, even in a case where displayable information is limited in the notification area for displaying the state information indicating the state of the own device, it is possible to prevent occurrence of a situation in which the state information important for the current user is not displayed corresponding to the operator.

According to the information processing device of the fourth aspect of the disclosure, even in a case where displayable information is limited in the notification area for displaying the state information indicating the state of the own device, it is possible to prevent occurrence of a situation in which the state information important for the current user is not displayed according to the progress status of the processing performed by the operator via the terminal device.

According to the information processing device of the fifth aspect of the disclosure, even in a case where displayable information is limited in the notification area for displaying the state information indicating the state of the own device, it is possible to prevent occurrence of a situation in which the state information important for the current user is not displayed according to the progress status of the processing performed by the operator via the terminal device.

According to the information processing device of the sixth aspect of the disclosure, even in a case where a screen to be displayed is switched among a plurality of operation screens and displayed on the terminal device, it is possible to prevent occurrence of a situation in which state information important for the current user is not displayed on each operation screen.

According to the program of the seventh aspect of the disclosure, even when displayable information is limited in the notification area for displaying the state information indicating the state of the own device, it is possible to prevent occurrence of a situation in which the state information important for the current user is not displayed.

### BRIEF DESCRIPTION OF DRAWINGS

FIG. 1 shows a diagram illustrating a system configuration of an image forming system according to a first embodiment of the disclosure.

FIG. 2 shows a block diagram illustrating a hardware configuration of an image forming apparatus according to the first embodiment of the disclosure.

FIG. 3 shows a block diagram illustrating a functional configuration of the image forming apparatus according to the first embodiment of the disclosure.

FIG. 4 shows a display example of an operation screen displayed on a terminal device.

FIG. 5 shows a diagram illustrating a content of processing for displaying state information with a high order of priority in a notification area.

FIG. 6 shows a flowchart for explaining an operation of the image forming apparatus according to the first embodiment of the disclosure.

FIG. 7 shows a display example of an operation screen displayed on a terminal device, and is a display example of an operation screen in a state where an administrator logs in.

FIG. 8 shows a display example of the operation screen displayed on the terminal device, and is a display example of the operation screen in a state of not being logged in.

FIG. 9 shows a diagram illustrating an example of a priority management table according to a second embodiment of the disclosure.

FIG. 10 shows a display example of the operation screen displayed on the terminal device, and is a diagram illustrating a state in which print setting is performed on a home screen.

FIG. 11 shows a diagram illustrating an example of a priority management table according to a third embodiment of the disclosure.

### DESCRIPTION OF EMBODIMENTS

### First Embodiment

Hereinafter, exemplary embodiments for carrying out the technology of the disclosure will be described in detail with reference to the drawings.

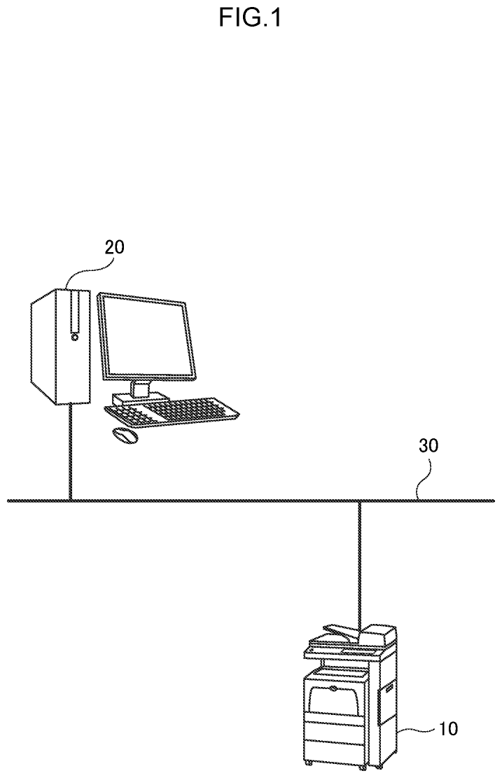

FIG. 1 is a diagram illustrating a system configuration of an image forming system according to a first embodiment; As illustrated in FIG. 1, the image forming system of the present embodiment includes an image forming apparatus 10 and a terminal device 20 connected to each other by a network 30.

In the image forming system, various operations can be performed on the image forming apparatus 10 from an operation screen of the terminal device 20. Further, the terminal device 20 generates print data and transmits the generated print data to the image forming apparatus 10 via the network 30. The image forming apparatus 10 receives print data transmitted from the terminal device 20 and outputs an image corresponding to the print data on a sheet. The image forming apparatus 10 is a so-called multi-function machine having a plurality of functions such as a printing function, a scanning function, a copying function, and a facsimile function.

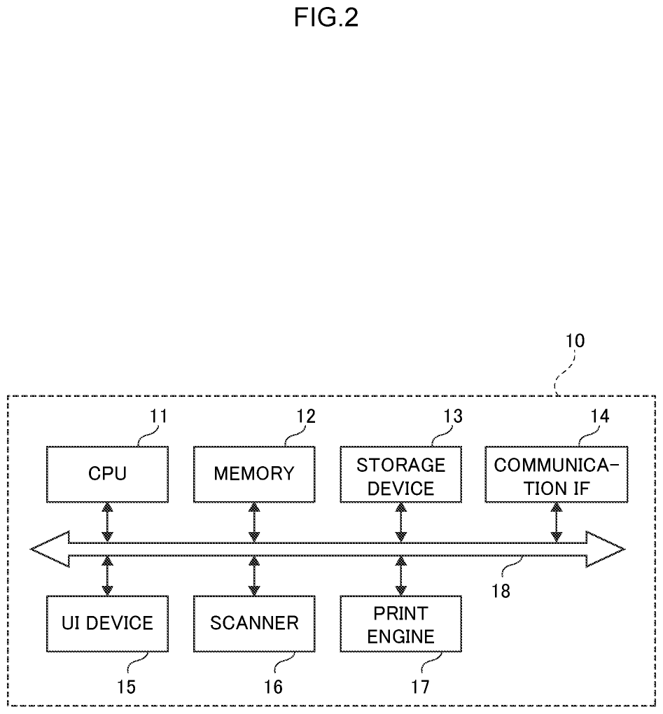

Next, a hardware configuration of the image forming apparatus 10 in the image forming system of the present embodiment is illustrated in FIG. 2.

As illustrated in FIG. 2, the image forming apparatus 10 includes a central processing unit (CPU) 11, a memory 12, a storage device 13 such as a hard disk drive, a communication interface (abbreviated as IF) 14 that transmits and receives data to and from an external device or the like via the network 30, a user interface (abbreviated as UI) device 15 including a touch panel or a liquid crystal display and a keyboard, a scanner 16, and a print engine 17. These components are connected to each other via a control bus 18.

The print engine 17 prints an image on a recording medium such as printing paper through processes such as charging, exposure, development, transfer, and fixing.

The CPU 11 is a processor that executes predetermined processing based on a control program stored in the memory 12 or the storage device 13 to control the operation of the image forming apparatus 10. In the present embodiment, the CPU 11 is described as reading and executing a control program stored in the memory 12 or the storage device 13, but the program may be stored in a storage medium such as a compact disc read only memory (CD-ROM) and provided to the CPU 11.

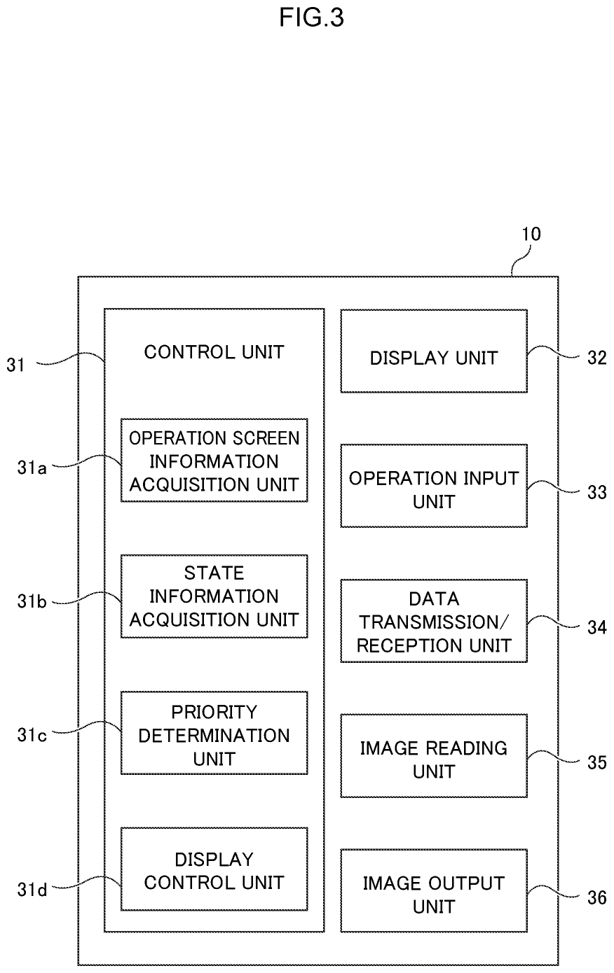

FIG. 3 is a block diagram illustrating a functional configuration of the image forming apparatus 10 realized by executing the control program.

As illustrated in FIG. 3, the image forming apparatus 10 of the present embodiment includes a control unit 31, a display unit 32, an operation input unit 33, a data transmission/reception unit 34, an image reading unit 35, and an image output unit 36.

The display unit 32 is controlled by the control unit 31 and displays various types of information to the user. The operation input unit 33 inputs various operation information performed by the user. The data transmission/reception unit 34 transmits and receives data to and from an external device such as the terminal device 20. The image reading unit 35 reads a document image from a set document under the control of the control unit 31. The image output unit 36 outputs an image on a recording medium such as printing paper under the control of the control unit 31.

The control unit 31 controls the overall operation of the image forming apparatus 10, generates print data based on a print job received from the terminal device 20 via the data transmission/reception unit 34, and performs control to output the generated print data from the image output unit 36 and read a document image by the image reading unit 35, and the like.

In addition, the control unit 31 displays an operation screen 40 for operating the image forming apparatus 10 on the terminal device 20 via the network 30 by, for example, browser display or the like. Moreover, the control unit 31 switches a screen to be displayed among a plurality of operation screens 40 and displays the screens on the terminal device 20, by an operation of a user. The control unit 31 has functions as an operation screen information acquisition unit 31a, a state information acquisition unit 31b, a priority determination unit 31c, and a display control unit 31d. Details of these functions will be described later.

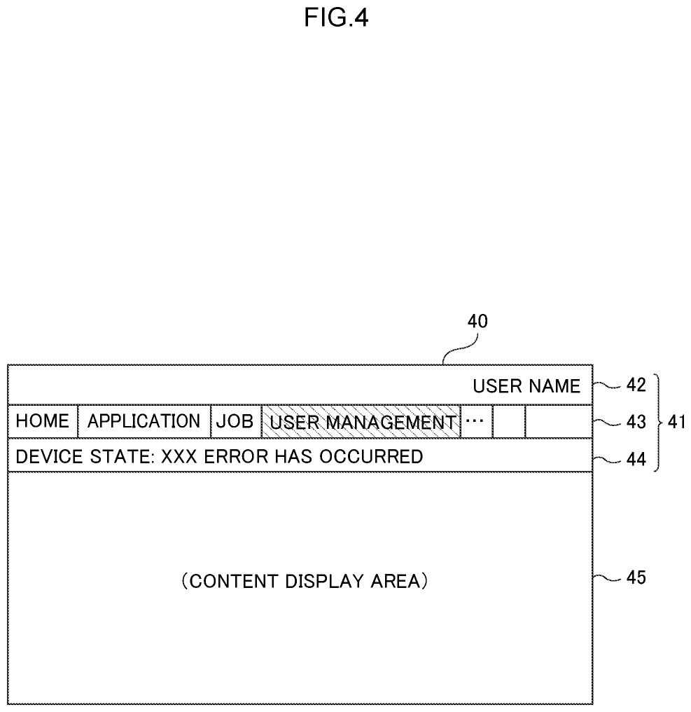

FIG. 4 is a display example of the operation screen 40 displayed on the terminal device 20. On the operation screen 40, the plurality of operation screens 40 having different contents for each function are displayed. As illustrated in FIG. 4, the operation screen 40 includes a constant display area 41 that is always displayed regardless of the function selected on the operation screen 40, and a content display area 45 in which content corresponding to the selected function is displayed.

The constant display area 41 includes a user name display area 42, a tab name display area 43, and a notification area 44.

The user name currently in use is displayed in the user name display area 42.

In the tab name display area 43, a tab displaying a name of a type classified for each function of the operation screen 40 is displayed. Examples of the type of tab displayed in the tab name display area 43 include a home, an application, a job, user management, and the like. When a tab is selected by the operation of the user, a content corresponding to the function of the selected tab is displayed in the content display area 45.

The notification area 44 is provided in a partial area of the operation screen 40. In the notification area 44, the state information of the image forming apparatus 10 acquired by the state information acquisition unit 31b is displayed. Here, the state information is information regarding some event related to the image forming apparatus 10, and includes, for example, information indicating abnormality of the image forming apparatus 10, information indicating that consumables inside the image forming apparatus 10 have run out, information indicating that there is an incomplete job in the image forming apparatus 10, information indicating that a plurality of users are accessing the image forming apparatus 10, information indicating that the image forming apparatus 10 is in a state requiring restart, and the like.

In the example illustrated in FIG. 4, as an example, the notification area 44 has a display area of one piece of state information. However, in the image forming apparatus 10, a plurality of pieces of state information may be simultaneously acquired depending on the situation. As a result, there may occur a situation in which state information having little relationship with the operation content is displayed for the current user, and state information important for the current operation content is not displayed.

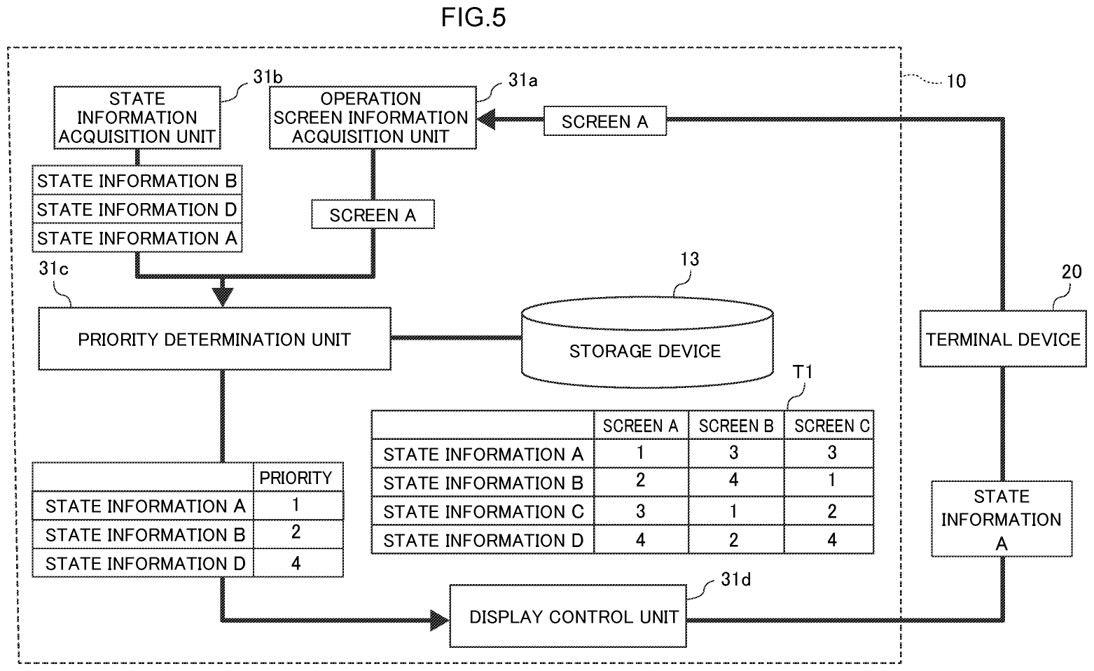

Therefore, in the image forming apparatus 10 of the present embodiment, an order of priority is set for each of the plurality of pieces of acquired state information, and contents that can be displayed in the notification area 44 of the operation screen 40 are displayed in the notification area 44 in descending order in the order of priority. FIG. 5 is a diagram illustrating the contents of processing for displaying state information with a high order of priority in the notification area 44.

As illustrated in FIG. 5, the operation screen information acquisition unit 31a acquires information of the operation screen 40 of the terminal device 20. The information on the operation screen 40 is information indicating contents displayed on the operation screen 40. In the present example, an example is illustrated in which information indicating that three types of screens of a screen A, a screen B, and a screen C can be displayed on the operation screen 40 and “screen A” is displayed as the information of the operation screen 40 is acquired.

The state information acquisition unit 31b acquires state information indicating the state of the image forming apparatus 10. In this example, three pieces of state information are acquired in the order of “state information B”, “state information D”, and “state information A”.

In a case in which there is a plurality of pieces of acquired state information, the priority determination unit 31c determines the order of priority of the state information to be displayed in the notification area 44 according to the display content of the operation screen 40 displayed on the terminal device 20, and changes the order of priority of the state information.

In the present embodiment, the priority determination unit 31c refers to a priority management table T1 stored in the storage device 13 to determine the order of priority of each piece of state information. In the priority management table T1, the display content of the operation screen 40 and the priority set in advance according to the content of the state information are recorded.

The priority management table T1 illustrated in FIG. 5 as an example includes three types of items of the screen A, the screen B, and the screen C as display contents of the operation screen 40. In addition, as the content of the state information, there are four types of items of the state information A, the state information B, the state information C, and the state information D. In addition, a numerical value of the priority corresponding to the display content of the operation screen 40 and the content of the state information means that the smaller the numerical value, the higher the priority.

In this example, the priority determination unit 31c refers to an item corresponding to the “screen A” in the priority management table T1, and determines that the order of priority of the “state information B” is “second”, the order of priority of the “state information D” is “fourth”, and the order of priority of the “state information A” is “first”.

The display control unit 31d displays the acquired state information in the notification area 44 of the operation screen 40. At this time, the display control unit 31d displays in the notification area 44 the pieces of state information displayable in the notification area 44 on the operation screen 40 in descending order in the order of priority among the plurality of pieces of state information. In the present example, an example is illustrated in which one piece of state information can be displayed in the notification area 44. Therefore, the display control unit 31d displays the “state information A” having the highest order of priority among the plurality of pieces of state information in the notification area 44.

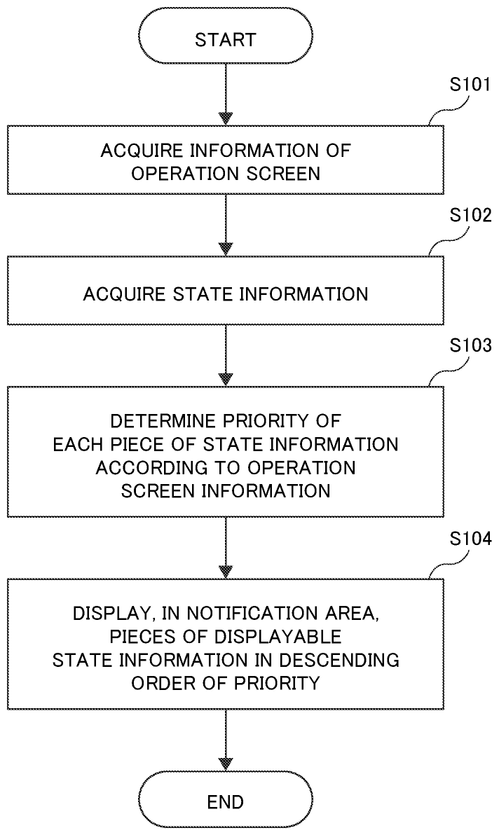

Next, the operation of the image forming apparatus 10 in the present embodiment will be described with reference to the flowchart of FIG. 6.

First, in Step S101, the operation screen information acquisition unit 31a acquires information of the operation screen 40 of the terminal device 20.

Next, in Step S102, the state information acquisition unit 31b acquires state information indicating the state of the image forming apparatus 10.

Next, in a case where there is a plurality of pieces of acquired state information in Step S103, the priority determination unit 31c determines the order of priority of each piece of state information according to the display content of the operation screen 40 displayed on the terminal device 20.

Then, in Step S104, the display control unit 31d displays in the notification area 44 the pieces of state information displayable in the notification area 44 on the operation screen 40 in descending order of priority among the plurality of pieces of state information.

### Second Embodiment

In the first embodiment, a mode in which the priority determination unit 31c changes the order of priority of the state information displayed in the notification area 44 according to the display content of the operation screen 40 displayed on the terminal device 20 has been described.

In the present embodiment, a mode will be described in which the priority determination unit 31c changes the order of priority of the state information displayed in the notification area 44 according to the display content of the operation screen 40 displayed on the terminal device 20 and authority of the user operating the terminal device 20.

Note that a hardware configuration (see FIGS. 1 to 3) of the image forming apparatus 10 according to the present embodiment is similar to that of the first embodiment, and thus description thereof is omitted. In addition, processing contents of the control unit 31 according to the present embodiment are similar to those of the first embodiment except for the priority determination unit 31c, and thus the description thereof will be omitted.

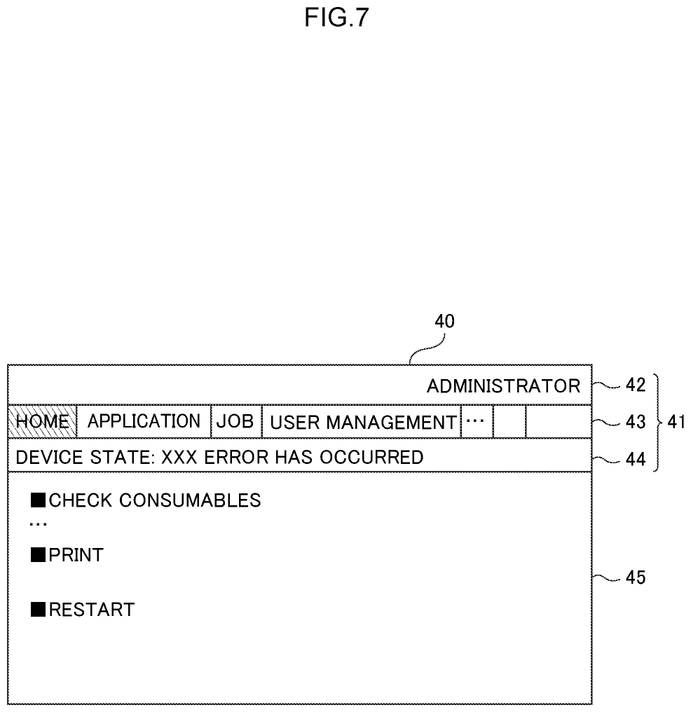

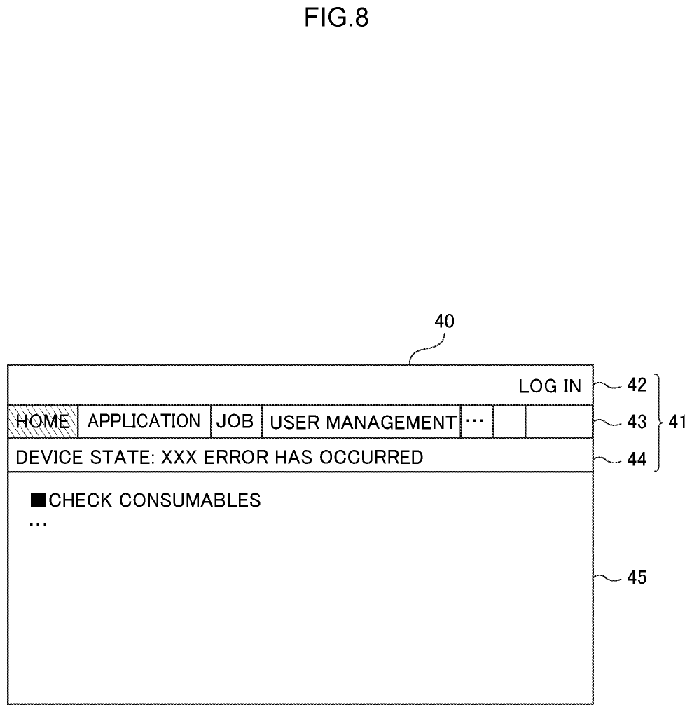

FIG. 7 is a display example of the operation screen 40 displayed on the terminal device 20, and is a diagram illustrating a home screen in a state where an administrator has logged in. FIG. 8 is a display example of the operation screen 40 displayed on the terminal device 20, and is a diagram illustrating a home screen in a non-logged-in state.

As illustrated in FIG. 7, in a state where the administrator is logged in, that is, in a state where the administrator is operating, items usable by the administrator are displayed in the content display area 45 of the home screen. In this example, items of “check consumables”, “print”, and “restart” are displayed in the content display area 45.

As illustrated in FIG. 8, in a state where the user is not logged in, that is, in a state where an unauthenticated user is operating, items that can be used by the unauthenticated user are displayed in the content display area 45 of the home screen. In this example, an item of “check consumables” is displayed in the content display area 45.

For example, the items of “print” and “restart” can be operated only by an authenticated user who has authority to operate “print” and “restart” such as an administrator. Therefore, in a state where an unauthenticated user who does not have the authority to operate “print” and “restart” is operating, these items are not displayed.

Even when the state information regarding “print” and “restart” is displayed in the notification area 44 in a state where an unauthenticated user is operating, the state information is not important information for an unauthenticated user who does not have authority to operate “print” and “restart”. Meanwhile, for an authenticated user having authority to operate “print” and “restart”, the state information regarding “print” or “restart” can be important information.

As described above, even when the types of the operation screens 40 are the same home screens, whether the state information displayed in the notification area 44 is important information or not depends on the authority of the operating user.

Therefore, in the present embodiment, the priority determination unit 31c determines the order of priority of the state information to be displayed in the notification area 44 according to the display content of the operation screen 40 displayed on the terminal device 20 and the authority of the user operating the terminal device 20, and changes the order of priority of the state information.

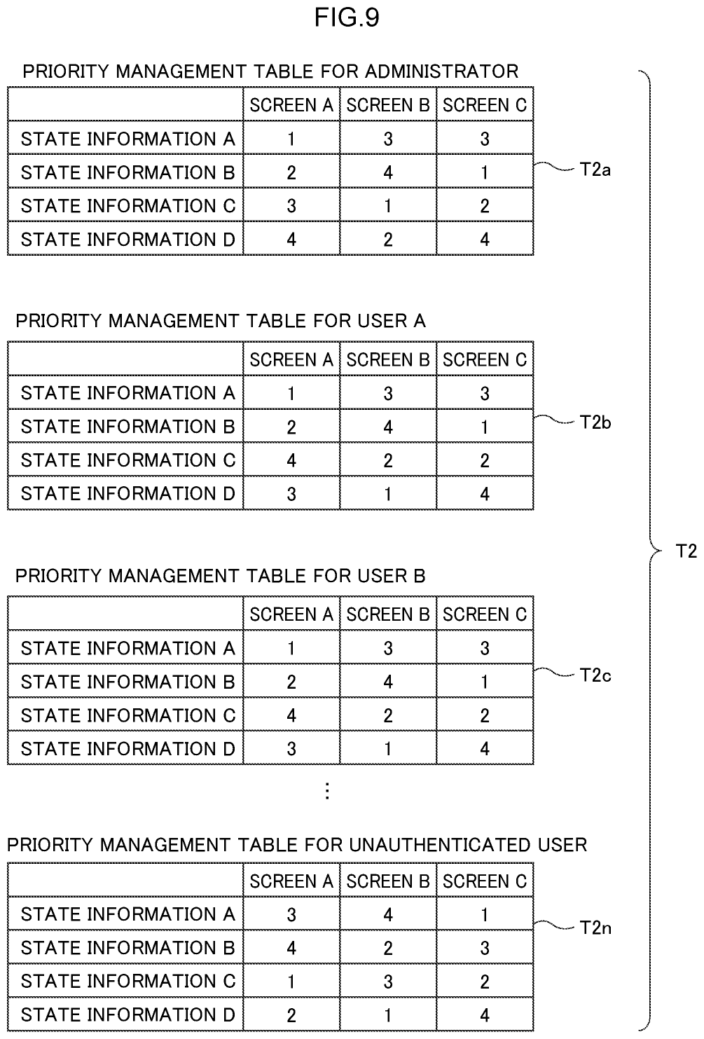

FIG. 9 is a diagram illustrating an example of a priority management table T2 according to the present embodiment. In the present embodiment, the priority determination unit 31c refers to the priority management table T2 stored in the storage device 13 to determine the order of priority of each piece of state information. The priority management table T2 includes a plurality of priority management tables T2a, T2b, T2c, . . . , and T2n provided for each user. In each of the priority management tables T2a, T2b, T2c, T2n, the display content of the operation screen 40 and the priority set in advance according to the content of the state information for each user are recorded.

For example, when the screen A is displayed as the operation screen 40 in a state where the administrator logs in, that is, in a state where the administrator operates, the priority determination unit 31c refers to the items of the screen A of the administrator priority management table T2a and determines the order of priority of the state information.

### Third Embodiment

In the present embodiment, a mode in which the priority determination unit 31c changes the order of priority of the state information displayed in the notification area 44 according to the display content of the operation screen 40 displayed on the terminal device 20 and a progress status of a job performed by the user via the terminal device 20 will be described.

Note that a hardware configuration (see FIGS. 1 to 3) of the image forming apparatus 10 according to the present embodiment is similar to that of the first embodiment, and thus description thereof is omitted. In addition, processing contents of the control unit 31 according to the present embodiment are similar to those of the first embodiment except for the priority determination unit 31c, and thus the description thereof will be omitted.

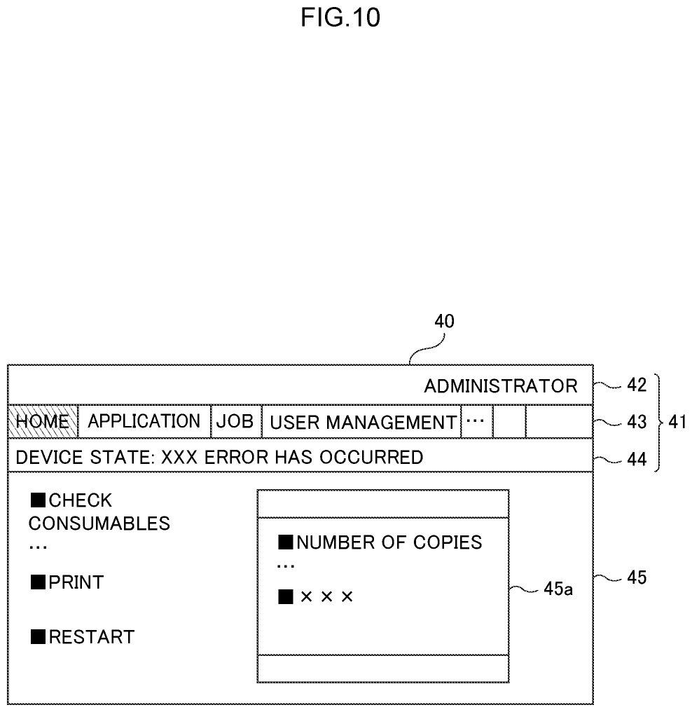

FIG. 7 illustrated above is a display example of the operation screen 40 displayed on the terminal device 20, and is a diagram illustrating a normal state of the home screen. FIG. 10 is a display example of the operation screen 40 displayed on the terminal device 20, and is a diagram illustrating a state in which print setting is performed on the home screen.

As illustrated in FIG. 7, in a state where the operation screen 40 is the home screen, items available on the home screen are displayed. In this example, items of “check consumables”, “print”, and “restart” are displayed in the content display area 45.

When an item is selected in the content display area 45 of the home screen, a detailed settings window 45a for performing detailed settings of each item is displayed in the content display area 45.

For example, as illustrated in FIG. 10, when “print” is selected in the content display area 45 while the operation screen 40 is in the home screen state, the detailed settings window 45a for performing detailed settings of “print” is displayed in the content display area 45.

During the “print” setting, information indicating that consumables such as printing paper run out is most important for the user, whereas during the “print” execution, information indicating the progress status of the job may be most important for the user.

As described above, even when the types of the operation screens 40 are the same home screens, whether the state information displayed in the notification area 44 is important information or not depends on the progress status of the job being executed by the user.

Therefore, in the present embodiment, the priority determination unit 31c determines the order of priority of the state information to be displayed in the notification area 44 according to the display content of the operation screen 40 displayed on the terminal device 20 and the progress status of the job performed by the user via the terminal device 20, and changes the order of priority of the state information.

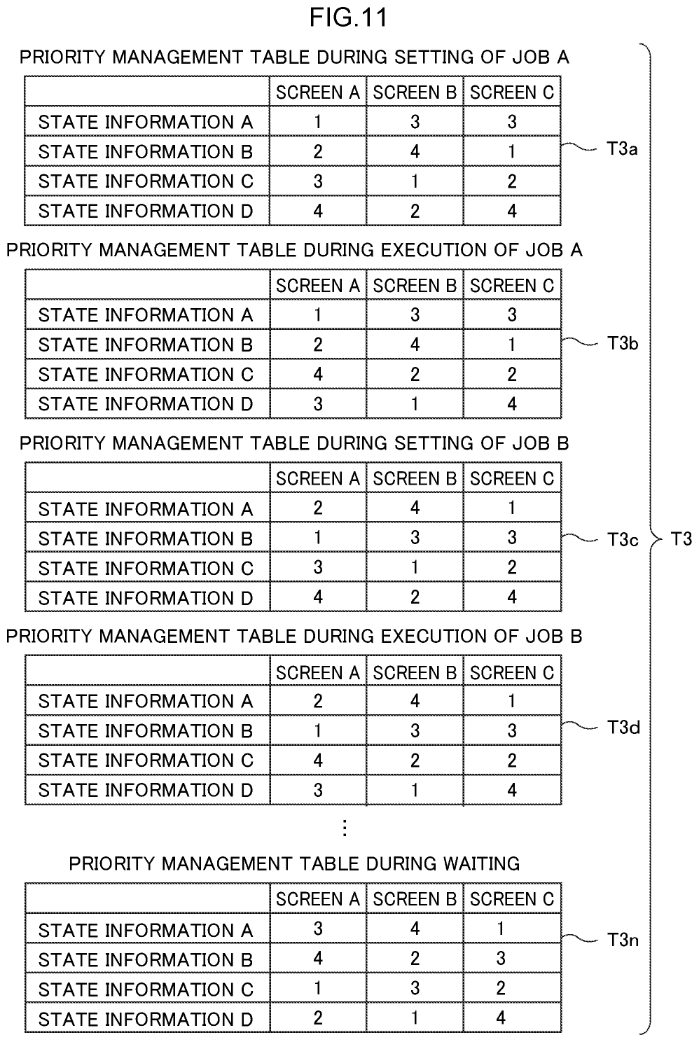

FIG. 11 is a diagram illustrating an example of the priority management table T3 according to the present embodiment. In the present embodiment, the priority determination unit 31c refers to the priority management table T3 stored in the storage device 13 to determine the order of priority of each piece of state information. The priority management table T3 includes a plurality of priority management tables T3a, T3b, T3c, T3d, . . . , and T3n provided for each progress status of the job. In each of the priority management tables T3a, T3b, T3c, T3d, . . . , and T3n, the display content of the operation screen 40 and the priority set in advance according to the content of the state information for each progress status of the job are recorded.

For example, when the job A is being set in a state where the screen A is displayed as the operation screen 40, the priority determination unit 31c refers to the items of the screen A in the job A setting priority management table T3a and determines the order of priority of the state information.

### MODIFICATION

In each of the above embodiments, a processor refers to a processor in a broad sense, and includes a general-purpose processor (for example, CPU: Central Processing Unit, etc.) or a dedicated processor (for example, GPU: Graphics Processing Unit, ASIC: Application Specific Integrated Circuit, FPGA: Field Programmable Gate Array, Programmable Logic Device, and the like).

In addition, the operation of the processor in each of the embodiments may be performed not only by one processor but also by a plurality of processors existing at physically separated positions in cooperation. In addition, the order of each operation of the processor is not limited to the order described in each of the embodiments and may be changed, as appropriate.

Furthermore, in the above-described embodiment, a case where the technology of the disclosure is applied to the image forming apparatus that forms the image on the recording medium has been described. However, the technology of the disclosure is not limited thereto, and the technology of the disclosure can be similarly applied to an information processing device such as a personal computer or a mobile terminal device that stores processing execution information for executing preset processing and executes processing using the stored processing execution information.

The disclosure of Japanese Patent Application No. 2021 024679 filed on Feb. 18, 2021 is incorporated herein by reference in its entirety. All documents, patent applications, and technical standards described in this specification are incorporated herein by reference to the same extent as each document, patent application, and technical standard were specifically and individually indicated to be incorporated by reference.

1. An information processing device comprising:
a processor configured to:
acquire state information which indicates a state of the information processing device,
cause display of the acquired state information in a notification area, which is a part of an operation screen for operating the information processing, when the operation screen is displayed on an external terminal device via a network, and
change an order of priority of the state information to be displayed in the notification area according to display content of the operation screen displayed on the terminal device, in a case in which there are a plurality of pieces of the acquired state information.

2. The information processing device according to claim 1, wherein the processor is configured to change the order of priority of the state information to be displayed in the notification area according to the display content of the operation screen displayed on the terminal device and authority of an operator operating the terminal device.

3. The information processing device according to claim 2, wherein the processor is configured to change the order of priority of the state information to be displayed in the notification area using a priority preset according to a content of the state information for each combination of the display content of the operation screen displayed on the terminal device and an executable operation determined based on the authority of the operator operating the terminal device.

4. The information processing device according to claim 1, wherein the processor is configured to change the order of priority of the state information to be displayed in the notification area according to the display content of the operation screen displayed on the terminal device and a progress status of the processing performed by an operator via the terminal device.

5. The information processing device according to claim 4, wherein the processor is configured to change the order of priority of the state information to be displayed in the notification area using a priority preset according to a content of the state information for each combination of the display content of the operation screen displayed on the terminal device and a current progress status of the processing performed by the operator via the terminal device.

6. The information processing device according to claim 1, wherein the processor is configured to switch a screen to be displayed among a plurality of operation screens and displays the screen on the terminal device, by an operation of an operator operating the terminal device.

7. A non-transitory computer-readable medium storing a program executable by a computer to perform:
a step of acquiring state information which indicates a state of an information processing device;
a step of displaying the acquired state information in a notification area, which is a part of an operation screen for operating the information processing device, when the operation screen is displayed on an external terminal device via a network; and
a step of switching an order of priority of the state information to be displayed in the notification area according to display content of the operation screen displayed on the terminal device, in a case in which there is a plurality of pieces of the acquired state information.
